(19) United States
(12) Patent Application Publication
(10) Pub. No.: US 2024/0077704 A1
(43) Pub. Date: Mar. 7, 2024

(54) TWO-STATE ZOOM FOLDED CAMERA

(71) Applicant: Corephotonics Ltd., Tel Aviv (IL)

(72) Inventors: Gil Bachar, Tel Aviv (IL); Gal Shabtay, Tel Aviv (IL); Ephraim Goldenberg, Tel Aviv (IL); Roy Rudnick, Tel Aviv (IL); Michael Dror, Tel Aviv (IL); Noy Cohen, Tel Aviv (IL)

(21) Appl. No.: 18/493,828

(22) Filed: Oct. 25, 2023

Related U.S. Application Data
(63) Continuation of application No. 18/178,604, filed on Mar. 6, 2023, now Pat. No. 11,852,790.
Application No. 18/178,604 is a continuation of application No. 17/268,104, filed on Feb. 12, 2021, now Pat. No. 11,635,596.
(60) Provisional application No. 62/720,939, filed on Aug. 22, 2018.

(51) Int. Cl. G02B 13/00; G02B 7/04; G02B 15/06; G02B 27/30

(52) U.S. Cl. CPC G02B 13/0065; G02B 7/04; G02B 13/003; G02B 15/06; G02B 27/30

(57) ABSTRACT

A zoom camera comprising an optical path folding element (OPFE) for folding the light from a first optical path to a second optical path, a first lens having a first optical axis and a first effective focal length EFL_{L1}, the first optical axis being along the second optical path, a collimating lens having a second optical axis, and an image sensor located on the second optical path, wherein the collimating lens is movable between at least a first state and a second state, wherein in the first state the collimating lens is positioned in the second optical path between the OPFE and the first lens such that light entering the first lens arrives only from the image side of the collimating lens, and wherein in the second state the collimating lens is positioned outside the first optical path such that light entering the first lens does not arrive from the image side of the collimating lens.

### CROSS REFERENCE TO RELATED APPLICATIONS

This is a continuation of U.S. patent application Ser. No. 18/178,604 filed Mar. 6, 2023 (now allowed), which was a continuation of U.S. patent application Ser. No. 17/268,104 filed Feb. 12, 2021 (issued as U.S. Pat. No. 11,635,596), which was a 371 application of international patent application PCT/IB2019/056846 filed Aug. 12, 2019, and claims the benefit of priority from U.S. provisional patent application No. 62/720,939 filed Aug. 22, 2018, which is incorporated herein by reference in its entirety.

### BACKGROUND

Cameras with folded optical paths (“also referred to as “folded cameras”) and zoom capabilities (also referred to herein as “zoom folded camera”), with lenses having lens elements in which relative lens element position is changed are known. In existing camera design, a high accuracy in relative lens shift is required, which leads to high costs and/or low manufacturing yield. This is particularly true in “miniature” or “compact” folded cameras of the type that may be used in mobile devices such as smartphones.

There is therefore a need for, and it would be advantageous to have miniature zoom cameras with high optical tolerance to low accuracy in relative lens shift.

### SUMMARY

In exemplary embodiments there are provided zoom cameras comprising an OPFE for folding the light from a first optical path to a second optical path, a first lens having a first optical axis and a first effective focal length EFL_{L1}, the first optical axis being along the second optical path, a collimating lens having a second optical axis, and an image sensor located on the second optical path, wherein the collimating lens is movable between at least two (first and second) states, wherein in the first state the collimating lens is positioned in the second optical path between the OPFE and the first lens such that light entering the first lens arrives only from the image side of the collimating lens, and wherein in the second state the collimating lens is positioned outside the first optical path, such that light entering the first lens does not arrive from the image side of the collimating lens.

In an exemplary embodiment, in the first state the camera has a first combined effective focal length EFL_{C1} different than EFL_{L1}, and in the second state the camera has a second combined effective focal length EFLc₂ equal to EFL_{L1}.

In an exemplary embodiment, a difference between EFL_{C1} and EFL_{C2} is of at least ±10%.

In an exemplary embodiment, a difference between EFL_{C1} and EFL_{C2} is of at least ±50%.

In an exemplary embodiment, a difference between EFL_{C1} and EFL_{C2} is of at least ±80%.

In an exemplary embodiment, in the first state, the first and second optical axes are parallel and a distance between the two optical axes does not change EFL_{C1}.

In an exemplary embodiment, in the first state, a distance between the first and collimating lenses does not change EFL_{C1}.

In some exemplary embodiments, the collimating lens is a telescopic lens.

In some exemplary embodiments, the first lens is operative to move along the first optical axis to change camera focus in both the first state and second state.

### BRIEF DESCRIPTION OF THE DRAWINGS

Aspects, embodiments and features disclosed herein will become apparent from the following detailed description when considered in conjunction with the accompanying drawings.

FIG. 1A shows an embodiment of a two-state zoom folded camera in a first state disclosed herein in a first operational mode in isometric view;

FIG. 1B shows the two-state zoom folded camera in a second operational mode in isometric view;

FIG. 1C shows the first and second operational mode of the camera of FIGS. 1A and 1B in a top view.

FIG. 2A shows a camera as in FIG. 1 with an exemplary optical design;

FIG. 2B shows the camera of FIG. 2A in a first operational state with ray tracing;

FIG. 2C shows the camera of FIG. 2A in a second operational state with ray tracing.

### DETAILED DESCRIPTION

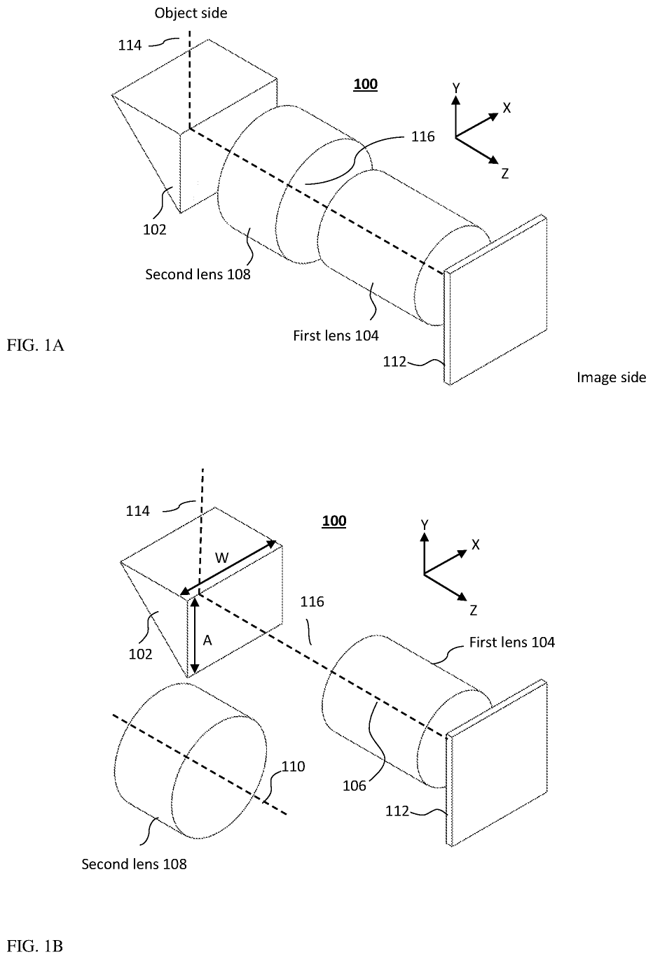

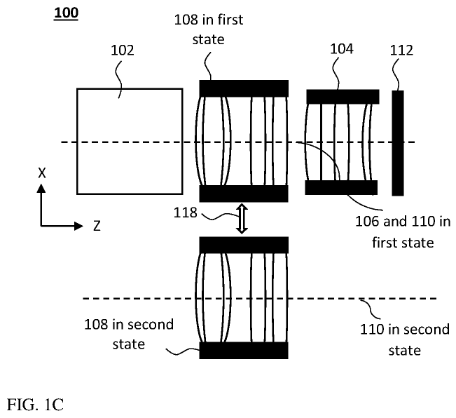

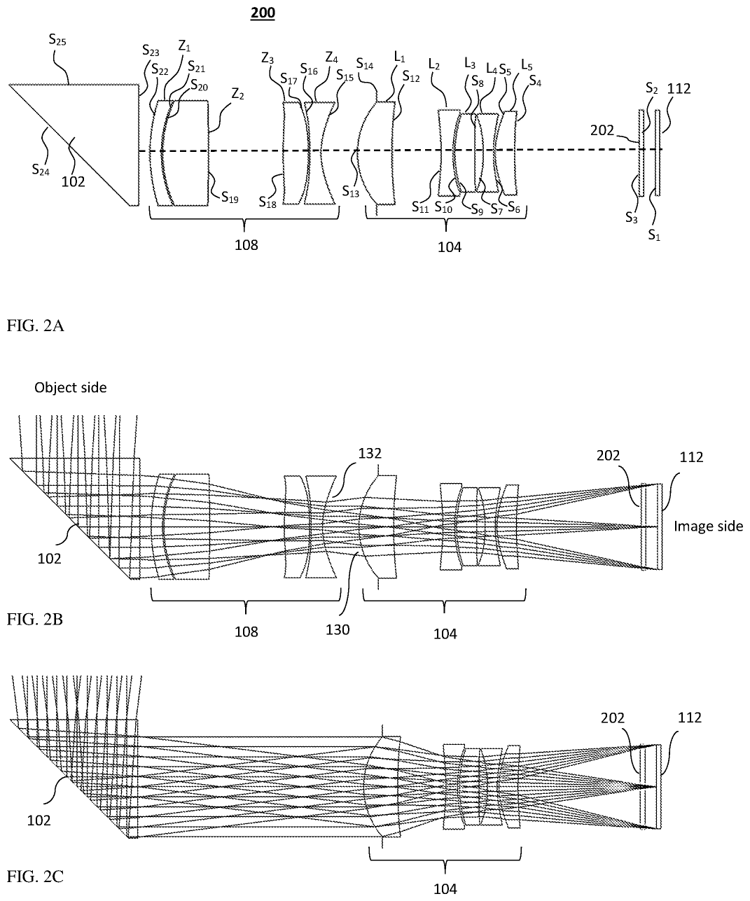

FIG. 1A shows an embodiment of a two-state zoom folded camera disclosed herein and numbered 100. FIGS. 1A and 1B show camera 100 from an isometric view in two different operational states, while FIG. 1C shows camera 100 from a top view, with camera 100 shown in two operational modes for illustration. The operational modes are described in more detail below. Camera 100 comprises an optical path folding element 102 (OPFE) (e.g. mirror, a prism), a first, imaging lens 104 with a first optical axis 106, a second, collimating lens 108 with a second optical axis 110 and an image sensor 112. OPFE 102 is capable of folding a light from a first optical path 114 to a second optical path 116. First lens 104 has a first effective focal length EFL_{L1}. First optical axis 106 is perpendicular to first optical path 114. Image sensor 112 is positioned with an image plane normal parallel to second optical axis 110 (i.e. the plane is perpendicular to the second optical axis). Camera 100 may include additional elements that are common in known cameras and are therefore not presented for simplicity. Such elements may comprise a protective shield, a protective optical window between the first lens and the image sensor to protect from dust and/or unneeded or unwanted light wavelengths (e.g. IR, ultraviolet (UV)), and other elements known in the art. In one example (shown below in FIGS. 2A-C), a protective optical window 202 between the first lens and the image sensor is presented.

Imaging lens 104 and collimating lens 108 may comprise each a single lens element or a plurality of lens elements. Embodiments of lenses 104 and 108 are shown in FIG. 1C with three and four lens elements respectively in an illustrative manner only. The number of lens elements in each lens may change (e.g. between 1 and 7 lens elements per lens)

In zoom camera 100, collimating lens 108 may shift mechanically between at least two operational states (or simply “states”).

FIG. 1A show camera 100 in a first operational state in which collimating lens 108 is located along second optical 116 path between OPFE 102 and first lens 104. In the first operational state, the camera 100 has a first effective camera focal length (EFL_{C}) EFL_{C1} that is equal to the combined power of the two lenses 104 and 108.

FIG. 1B show a second operational state in which collimating lens 108 is located away from the second optical path. In the second operational state, camera 100 has a second (combined) effective camera focal length EFL_{C2} equal to the first effective focal length EFL_{L1} of first lens 104.

FIG. 1C shows a top view of the system in the two operation modes, where an arrow 118 shows the motion direction of collimating lens 108.

The optical design of collimating lens 108 is such that EFL_{C2} is different from EFL_{C1}. According to an example, collimating lens 108 may be a telescopic lens, such that the introduction of the collimating lens 108 into the second optical path 116 increases or decreases EFL_{C} from EFL_{C2} to EFL_{C1}. According to an example, EFL_{C2} is different (smaller or larger) by more than 10% from EFL_{C1}. According to an example, EFL_{C2} is different by more than 80% from EFL_{C2}. According to an example, EFL_{C2} is in the range of 10-18 mm and EFL_{C1} is in the range of 20-36 mm. According to an example, EFL_{C2} is in the range of 10-18 mm and EFL_{C1} is in the range of 5-9 mm.

FIGS. 2A-C show an embodiment of a camera numbered 200 that has an exemplary optical design given in Tables 1-3 below. FIG. 2A shows camera 200 in the first operational state. In camera 200, first lens 104 comprises five lens elements marked L1 to L5 and collimating lens 108 comprises 4 lens elements marked Z1 to Z4. As mentioned, the number of lens elements in each lens is exemplary, and in other optical designs the number of lens elements may be different (e.g. 1-7 lens element in each lens). In camera 200, OPFE 102 is a prism. In camera 200, a protective glass 202 is added to the optical design.

Tables 1-3 below provide the optical design of camera 200. The surfaces of various optical elements are listed starting from the sensor 112 (image) side to the prism 102 (object) side. Table 1 provide data for all the surfaces except the prism surfaces: “type” is the surface type (flat or aspheric), R is the surface radius of curvature, T is the surface thickness, Nd is the surface refraction index, Vd is the surface Abbe number, D/2 is the surface semi diameter. Table 2 provide aspheric data for aspheric surfaces in Table 1, according to the following formula:

$$Q type 1 surface sag formula :$$

$$z = \frac{c {r}^{2}}{1 + \sqrt{1 - ( 1 + k ) {c}^{2} {r}^{2}}} + {D}_{c o n} ( u )$$

$${D}_{c o n} ( u ) = {u}^{4} {\sum }_{n = 0}^{N} {A}_{n} {Q}_{n}^{c o n} ( {u}^{2} )$$

$$u = \frac{r}{{r}_{max}} ,$$

$$x = {u}^{2}$$

$${Q}_{0}^{c o n} ( x ) = 1$$

$${Q}_{1}^{c o n} = - ( 5 - 6 x )$$

$${Q}_{2}^{c o n} = 15 - 14 x ( 3 - 2 x )$$

$${Q}_{3}^{c o n} = - \{ 35 - 12 x [ 14 - x ( 21 - 10 x ) ] \}$$

$${Q}_{4}^{c o n} = 70 - 3 x \{ 168 - 5 x [ 84 - 11 x ( 8 - 3 x ) ] \}$$

$${Q}_{5}^{c o n} = - [ 126 - x ( 1260 - 11 x \{ 420 - x [ 720 - 13 x ( 45 - 14 x ) ] \} ) ]$$

where {z, r} are the standard cylindrical polar coordinates, c is the paraxial curvature of the surface, k is the conic parameter, rₘₐₓ is one half of the surfaces clear aperture, and Aₙ are the polynomial coefficients shown in lens data tables.

Table 3 provide data for surfaces of prism 202 only: A is the prism (without bevel) face length, W is the face width, and other fields are like in Table 1. Note that a prism may or may not have a bevel.

In camera 200, first lens 104 has an EFL of 15 mm. The design of second (collimating) lens 108 is of a telescopic lens. Lens 108 in camera 200 has a magnification ratio of 2: two lens elements L1 and L2 form a positive doublet with a focal length of 15 mm and two lens elements L3 and L4 form a negative doublet with a focal length of −7.5 mm. As a result, when in the first operational state, the camera has an EFL of EFL_{C1}=30 mm. When in the second operation state, the camera has an EFL of EFL_{C2}=EFL_{L1}=15 mm. In another example, replacing collimating lens 108 with a lens having a magnification ratio of 0.5 (e.g. by using a first negative doublet with a focal length of −15 mm and a second positive doublet with a focal length of 7.5 mm) would result in decreasing EFL_{C} by factor of 2. Thus, in this example, the ratio EFL_{C1}/EFL_{C2} in cameras 100 and 200 can be in the range of 0.2 to 5.

The telescopic design of collimating lens 108 allows for a less accurate positioning of collimating lens 108 relative to first lens 104: a shift and/or tilt of collimating lens 108 in any direction (in particular shift along first optical axis 106, shift perpendicular to first optical axis 106, and/or rotation of the lens) will not change the magnification ratio. For example, relative to a nominal position (presented in FIG. 2 and Tables 1-3) in which first optical axis 106 of first lens 104 and second optical axis 110 of collimating lens 108 coincide (merge), and distances between the first lens and the collimating lens are given (Table 1), the collimating lens can move in any direction (X, Y, Z) by up to 50 μm, 100 μm or even 0.2 mm, and rotate in any direction (yaw, pitch, roll) by 0.5 degree, 1 degrees or 2 degrees without affecting or minimally affecting camera operation.

Note that in the first state, the first and second optical axes are parallel and a change in distance between the two optical axes does not change EFL_{C1}. Similarly, a change in distance between the first and collimating lenses does not change EFL_{C1}. That is, in the first state, EFL_{C1} is substantially independent of the distance between optical axes of, or distances between lenses 104 and 108.

FIG. 2B shows camera 200 in the first operational state with ray tracing. The optical design of camera 200 is such that in the first state light entering first lens 104 at an object side 130 is coming (arrives) only from an image side 132 of collimating lens 108. FIG. 2C shows camera 200 in the second operational state with ray tracing. The optical design of camera 200 is such that in the second operational state light entering first lens 104 at object side 130 is not coming from image side 132 of collimating lens 108 (i.e. it bypasses collimating lens 108) but comes directly from OPFE 102.

In cameras 100 and 200, focusing in both operational states may be performed by moving first lens 104 along first optical axis 106. In both cameras, optical image stabilization (OIS) in both operational states may be performed by moving first lens 104 perpendicular to optical axis 106 and/or by tilting OPFE 102 and/or by combining shift of first lens 104 and tilt of OPFE 102. These actions may be performed using actuators or mechanisms known in the art.

TABLE 1

| # | Comment | Type | R [mm] | T [mm] | Nd | Vd | D/2 [mm] |
|---|---|---|---|---|---|---|---|
| S₁ | Image | flat | Infinity | 0.500 | | | 1.878 |
| S₂ | IR Filter | flat | Infinity | 0.210 | 1.516 | 64.167 | 1.900 |
| S₃ | | flat | Infinity | 5.460 | | | 1.900 |
| S₄ | L₅S₂ | Q-Type Aspheric | −13.571 | 0.853 | 1.650 | 21.513 | 1.831 |
| S₅ | L₅S₁ | Q-Type Aspheric | −2.840 | 0.079 | | | 1.797 |
| S₆ | L₄S₂ | Q-Type Aspheric | −3.728 | 0.436 | 1.534 | 55.663 | 1.706 |
| S₇ | L₄S₁ | Q-Type Aspheric | 6.712 | 0.368 | | | 1.648 |
| S₈ | L₃S₂ | Q-Type Aspheric | −248.667 | 0.883 | 1.534 | 55.663 | 1.654 |
| S₉ | L₃S₁ | Q-Type Aspheric | −4.471 | 0.081 | | | 1.706 |
| S₁₀ | L₂S₂ | Q-Type Aspheric | −5.197 | 0.518 | 1.650 | 21.513 | 1.706 |
| S₁₁ | L₂S₁ | Q-Type Aspheric | 9.451 | 2.152 | | | 1.895 |
| S₁₂ | L₁S₂ | Q-Type Aspheric | −24.950 | 1.523 | 1.484 | 84.146 | 2.250 |
| S₁₃ | L₁S₁ | Q-Type Aspheric | −3.349 | −0.840 | | | 2.250 |
| S₁₄ | Stop | flat | Infinity | 2.435 | | | 2.250 |
| S₁₅ | Z₄S₂ | Q-Type Aspheric | −3.166 | 0.500 | 1.829 | 42.726 | 2.230 |
| S₁₆ | Z₄S₁ | Q-Type Aspheric | 38.480 | 0.060 | | | 2.230 |
| S₁₇ | Z₃S₂ | Q-Type Aspheric | 12.476 | 1.111 | 1.650 | 21.513 | 2.230 |
| S₁₈ | Z₃S₁ | Q-Type Aspheric | −11.693 | 3.270 | | | 2.230 |
| S₁₉ | Z₂S₂ | Q-Type Aspheric | 88.558 | 2.000 | 1.665 | 55.117 | 2.300 |
| S₂₀ | Z₂S₁ | Q-Type Aspheric | −5.530 | 0.060 | | | 2.300 |
| S₂₁ | Z₁S₂ | Q-Type Aspheric | −5.556 | 0.500 | 2.005 | 21.000 | 2.300 |
| S₂₂ | Z₁S₁ | Q-Type Aspheric | −7.644 | 0.500 | | | 2.300 |

TABLE 2

| # | k | rₘₐₓ | A₀ | A₁ | A₂ | A₃ | A₄ | A₅ |
|---|---|---|---|---|---|---|---|---|
| S₄ | −0.834 | 1.858 | 3.55E−02 | −6.06E−03 | 2.26E−04 | 5.15E−04 | −2.26E−04 | −2.10E−05 |
| S₅ | −6.008 | 1.858 | 1.50E−02 | −1.73E−02 | 6.19E−03 | −1.50E−03 | 7.16E−05 | −1.84E−05 |
| S₆ | −17.754 | 1.833 | 3.32E−02 | −1.56E−02 | 6.87E−03 | −4.24E−03 | 1.27E−03 | −4.59E−04 |
| S₇ | −8.169 | 1.833 | 1.56E−01 | −1.90E−02 | 4.15E−03 | −8.86E−04 | 5.73E−03 | 4.55E−04 |
| S₈ | 116.131 | 1.903 | 2.11E−03 | 2.66E−02 | 3.50E−02 | 1.36E−02 | 1.03E−02 | 2.09E−03 |
| S₉ | −1.064 | 1.903 | 7.70E−02 | −3.48E−03 | 9.94E−03 | −3.66E−03 | −1.75E−03 | −1.37E−03 |
| S₁₀ | −1.581 | 1.953 | −1.10E−01 | −8.34E−02 | −4.32E−02 | −2.31E−02 | −9.94E−03 | −2.84E−03 |
| S₁₁ | −3.312 | 1.953 | −7.74E−02 | 3.73E−03 | −3.48E−03 | 5.87E−04 | −3.68E−04 | 5.19E−05 |
| S₁₂ | −81.481 | 2.754 | −8.12E−02 | 6.15E−03 | 4.95E−05 | 1.13E−04 | −6.61E−05 | −1.87E−06 |
| S₁₃ | −0.263 | 2.754 | −6.88E−02 | −8.71E−03 | −1.15E−03 | −1.54E−05 | −6.84E−07 | 9.92E−08 |
| S₁₅ | −0.624 | 3.600 | 8.51E−01 | −2.00E−01 | 2.69E−02 | −4.74E−03 | 0.00E+00 | 0.00E+00 |
| S₁₆ | −99.998 | 3.600 | 5.34E−02 | −3.81E−01 | 1.98E−02 | −1.08E−02 | 0.00E+00 | 0.00E+00 |
| S₁₇ | 5.259 | 3.600 | 1.69E+00 | 1.57E−01 | 6.69E−02 | −5.86E−03 | 0.00E+00 | 0.00E+00 |
| S₁₈ | −3.735 | 3.600 | 2.85E+00 | 6.02E−01 | 8.16E−02 | 2.81E−04 | 0.00E+00 | 0.00E+00 |
| S₁₉ | −29.541 | 3.750 | 5.18E−02 | 2.26E−02 | −2.67E−03 | −7.68E−04 | 0.00E+00 | 0.00E+00 |
| S₂₀ | −0.096 | 3.750 | −4.51E−02 | 2.86E−02 | 3.54E−03 | 2.66E−04 | 0.00E+00 | 0.00E+00 |
| S₂₁ | 0.022 | 3.750 | −5.04E−02 | 3.29E−02 | 9.80E−03 | 2.21E−03 | 0.00E+00 | 0.00E+00 |
| S₂₂ | 0.548 | 3.750 | −1.41E−02 | −1.70E−02 | −4.03E−03 | −7.61E−04 | 0.00E+00 | 0.00E+00 |

TABLE 3

| | | R | T | | | A/2 | W/2 |
|---|---|---|---|---|---|---|---|
| # | Type | [mm] | [mm] | Nd | Vd | [mm] | [mm] |
| S₂₃ | Prism Object side | Infinity | 3.050 | 1.840 | 23.000 | 2.850 | 3.000 |
| S₂₄ | Prism Reflective | Infinity | −2.650 | 1.840 | 23.000 | — | — |
| | face | | | | | | |
| S₂₅ | Prism Image side | Infinity | — | | | 2.850 | 3.000 |

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A zoom camera, comprising:
a single optical path folding element (OPFE) for folding the light from a first optical path to a second optical path;
a first lens having a first optical axis and a first effective focal length EFL_{L1} and including N_{L1} lens elements, the first optical axis being along the second optical path;
a collimating lens having a second optical axis and a second effective focal length EFL_{L2}, and including N_{L2} lens elements; and
an image sensor located on the second optical path,
wherein the collimating lens is movable to provide at least a first lens state with a combined effective camera focal length EFL_{C1} and a second lens state with a combined effective camera focal length EFL_{C2}, wherein both EFL_{C1} and EFL_{C2} are different from EFL_{L1}, wherein in the first lens state the collimating lens is positioned in the second optical path between an image side of the single OPFE and the first lens such that light entering the first lens arrives only from the image side of the collimating lens, and wherein in the second state the collimating lens is positioned outside the second optical path such that light entering the first lens arrives directly from the image side of the single OPFE and does not arrive from the image side of the collimating lens.

2. The zoom camera of claim 1, wherein a first lens element and a second lens element of the collimating lens form a positive doublet, and wherein a third lens element and a fourth lens element of the collimating lens form a negative doublet.

3. The zoom camera of claim 2, wherein a focal length of the positive doublet is 15 mm, wherein a focal length of the negative doublet is −7.5 mm.

4. The zoom camera of claim 1, wherein a first lens element and a second lens element of the collimating lens form a negative doublet, and wherein a third lens element and a fourth lens element of the collimating lens form a positive doublet.

5. The zoom camera of claim 4, wherein a focal length of the positive doublet is 7.5 mm, wherein a focal length of the negative doublet is −15 mm.

6. The zoom camera of claim 1, wherein N_{L1}=5.

7. The zoom camera of claim 1, wherein N_{L2}=4.

8. The zoom camera of claim 1, wherein for switching between the first lens state and the second lens state, the collimating lens is shifted mechanically between at least two operational states.

9. The zoom camera of claim 1, wherein the collimating lens can move in any direction by up to 0.2 mm without affecting camera operation.

10. The zoom camera of claim 1, wherein the collimating lens can move in any direction by up to 100 μm without affecting camera operation.

11. The zoom camera of claim 1, wherein the collimating lens can move in any direction by up to 50 μm without affecting camera operation.

12. The zoom camera of claim 1, wherein the collimating lens can rotate in any direction by 2 degrees without affecting camera operation.

13. The zoom camera of claim 1, wherein the collimating lens can rotate in any direction by 1 degrees without affecting camera operation.

14. The zoom camera of claim 1, wherein the collimating lens can rotate in any direction by 0.5 degrees without affecting camera operation.

15. The zoom camera of claim 1, wherein the collimating lens is a telescopic lens.

16. The zoom camera of claim 1, wherein the first lens is operative to move along the first optical axis to change camera focus.

17. The zoom camera of claim 1, wherein the first lens is operative to move to perform optical image stabilization.

18. The zoom camera of claim 1, wherein the OPFE is operative to move to perform optical image stabilization.

19. The zoom camera of claim 1, wherein the zoom camera is included in a mobile device.

20. The zoom camera of claim 19, wherein the mobile device is a smartphone.
